(19) United States
(12) Patent Application Publication
(10) Pub. No.: US 2026/0340584 A1
(43) Pub. Date: Oct. 29, 2026

(54) SYSTEM AND METHOD FOR DETECTING UNRECORDED RETAIL INVENTORY USING MACHINE LEARNING AND DISTRIBUTED COMPUTING

(71) Applicant: Target Brands, Inc.,, Minneapolis, MN (US)

(72) Inventors: Matthew Norton, Sunnyvale, CA (US); Eric Viscuso, Big Lake, MN (US); Xinbo Wang, Menlo Park, CA (US); Samantha Schumacher, Roseville, MN (US); Swapnil Deshpande, Lakeville, MN (US)

(73) Assignee: Target Brands, Inc., Minneapolis, MN (US)

(21) Appl. No.: 19/656,639

(22) Filed: Apr. 23, 2026

Related U.S. Application Data
(60) Provisional application No. 63/794,524, filed on Apr. 25, 2025.

(51) Int. Cl. G06Q 10/087; G06Q 10/04

(52) U.S. Cl. CPC G06Q 10/08772; G06Q 10/04

(57) ABSTRACT

Systems and methods for detecting unrecorded retail inventory using machine learning and distributed computing are provided. A modular pipeline design processes backroom locations daily, across one or more retail store locations on a recurring basis (e.g. daily), combining short-term transaction details and long-term aggregated metrics to identify potential unrecorded inventory items. A secondary gatekeeper model handles distribution shifts in data patterns. The system generates prioritized, sublocation-specific, audit tasks within operational time constraints such that they may be executed via downstream user computing devices, thereby enabling systematic identification and recovery of unrecorded inventory in retail store backrooms.

### CROSS-REFERENCE TO RELATED APPLICATIONS

This application claims priority to U.S. Provisional Patent Application Ser. No. 63/794,524 filed on Apr. 25, 2025, the disclosure of which is hereby incorporated by reference in its entirety.

### BACKGROUND

Inventory record inaccuracies (IRIs) relate to failures in maintaining 100% accurate records of every inventory unit, which is inevitable for major retailers having more than 100,000 stock keeping units (SKUs) across hundreds, or even thousands, of retail locations. As one example, IRIs can include phantom inventory: inventory being recorded as physically present, though it is, in fact, absent (e.g. due to damage, recording error, or the like) which can subsequently result in compounding upstream or downstream supply chain errors (e.g. a lack of automated replenishment, stock outs, etc.) In addition to IRIs, simple misplacement of SKUs (e.g. hidden or lost inventory items) can also result in supply chain errors in addition to significant waste (e.g. “expiry” of misplaced items both in terms of perishable goods and seasonal items, and the like).

### SUMMARY

In accordance with aspects of this disclosure, systems for detecting unrecorded retail inventory using machine learning and distributed computing are provided. A machine learning-driven audit recommendation system for improved detection and recovery of unrecorded inventory is integrated with a user interface coupled with a barcode scanner to seamlessly enable real-time finding and recording of unrecorded inventory. In this manner, guest experience can be improved by reducing sales floor stockouts, increasing backroom storage capacity, and, at an enterprise scale, reducing waste in terms of identifying and selling misplaced stock before it expires, moves out of season, or a replacement is erroneously ordered.

In accordance with a first aspect of the disclosure, a computer-implemented method is provided for detecting unrecorded retail inventory. The method includes receiving inventory movement data and historical audit data from a plurality of retail store locations. The method further includes generating a feature set comprising short-term features and long-term features. The feature set is processed using a machine learning model configured to generate probability scores identifying backroom sublocations most likely to contain one or more unrecorded inventory items. The method further includes generating a plurality of audit tasks for backroom sublocations based on the probability scores. One or more of the plurality of audit tasks are executed and the machine learning model is updated based on feedback data from the executed audit tasks.

In accordance with a second aspect of the disclosure, a system is provided for detecting unrecorded retail inventory. The system includes one or more processors and one or more memory devices storing instructions that, when executed by the one or more processors, cause the system to receive inventory movement data and historical audit data from a plurality of retail store locations. The system generates a feature set comprising short-term features and long-term features. The system processes the feature set using a machine learning model configured to generate probability scores identifying backroom sublocations most likely to contain one or more unrecorded inventory items. The system generates a plurality of audit tasks for backroom sublocations based on the probability scores. The system further executes one or more of the plurality of audit tasks and updates the machine learning model based on feedback data from the executed audit tasks.

In accordance with a third aspect of the disclosure, an audit recommendation system is provided for generating audit tasks within a retail enterprise. The system includes a non-transitory computer-readable medium storing instructions that, when executed by one or more processors, cause the one or more processors to receive inventory movement data and historical audit data from a plurality of retail store locations. A feature set comprising short-term features and long-term features is generated. The feature set is processed using a machine learning model configured to generate probability scores identifying backroom sublocations most likely to contain one or more unrecorded inventory items. A plurality of audit tasks for backroom sublocations are generated based on the probability scores. One or more of the plurality of audit tasks are executed, and the machine learning model is updated based on feedback data from the executed audit tasks.

### BRIEF DESCRIPTION OF THE DRAWINGS

FIG. 1 illustrates an example retail backroom having unrecorded inventory.

FIG. 2 illustrates an example network environment in which aspects of the present disclosure may be implemented.

FIG. 3 illustrates a schematic diagram of example components of an audit recommendation tool training pipeline.

FIG. 4 is a flowchart of an example method for serving audit tasks to a user device.

FIG. 5 is a flowchart of an example method for sending audit data to a gatekeeper model.

FIG. 6 illustrates a user interface, according to an example embodiment.

FIG. 7 is a block diagram of an example computing system with which aspects of the present disclosure may be implemented.

### DETAILED DESCRIPTION

As briefly mentioned above, embodiments of the present invention are directed to a machine learning-driven audit recommendation system for improved detection and recovery of misplaced backroom inventory, thereby improving guest experience by reducing sales floor stockouts, increasing backroom storage capacity, and, at an enterprise scale, reducing waste in terms of identifying and selling misplaced stock before it expires, moves out of season, or a replacement is erroneously ordered.

In example implementations, rather than conducting backroom audits at random or on a recurring basis (e.g. annually), the audit recommendation system described herein provides a proactive, automated approach to finding and fixing unrecorded inventory through training and deployment of a model, such as a probabilistic binary classification model. In embodiments, the model accounts for every backroom inventory sublocation (e.g. inventory holding bin) on a store-by-store basis and identifies the sublocations that are most likely to have at least one unrecorded inventory item (also referred to herein as “SKU”) at a given time.

Additionally, in some instances, the automated inventory sublocation audit tool includes a user interface for presentation of a prioritized list of daily backroom sublocation audit tasks, coupled to a barcode scanner for scanning of items in the identified sublocations, which together result in the automatic recording and identification of unrecorded inventory items and feedback to the recommendation model for future audit list generation.

In particular embodiments, the audit recommendation system described herein can be configured to automatically identify one or more backroom sublocations that are likely to contain one or more misplaced inventory items, generate an audit task for each of the identified backroom sublocations, and deliver the generated audit tasks to at least one user device for execution by store personnel such that misplaced inventory items can be identified and recovered before expiring, moving out of season, or unnecessary replenishment thereof is automatically or manually triggered by one or more enterprise or retail store inventory management system.

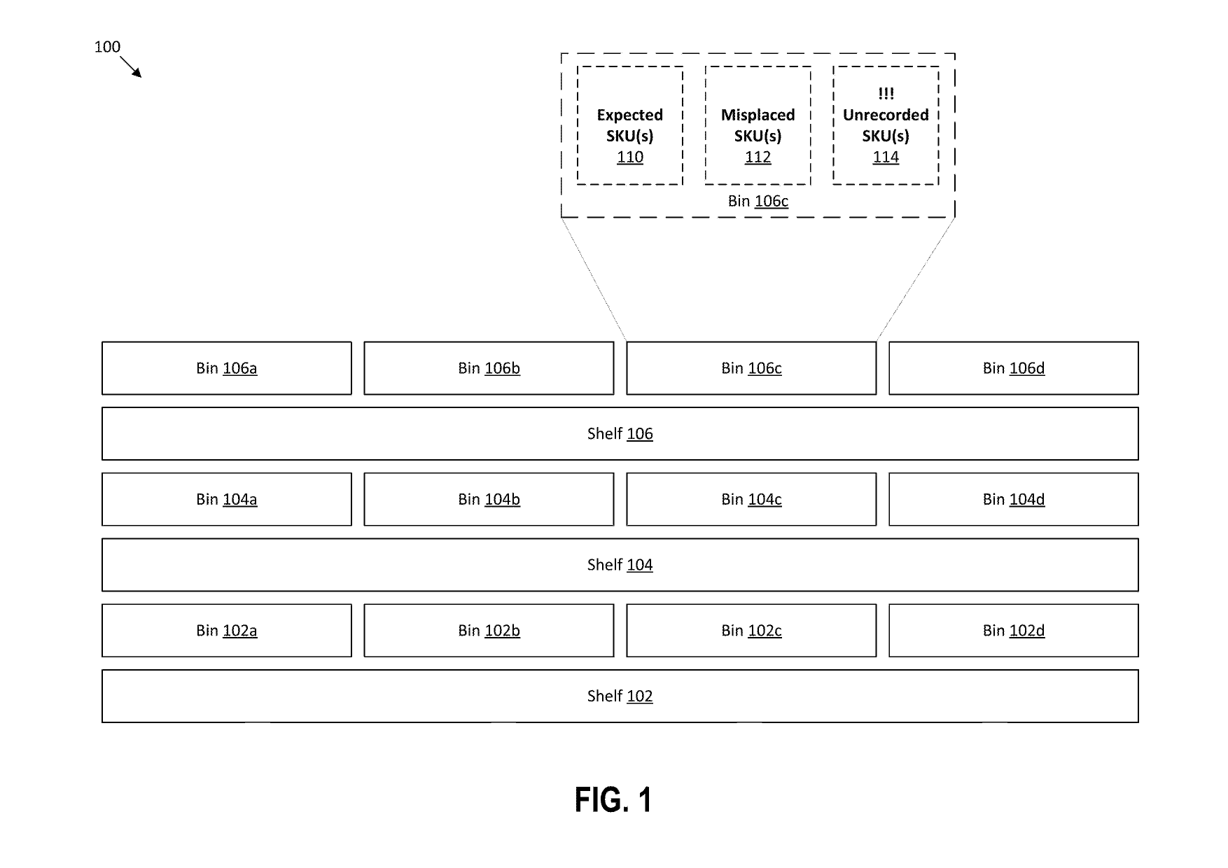

FIG. 1 illustrates an example retail backroom 100 having unrecorded inventory. In the example shown, the retail backroom 100 includes a plurality of shelves and a plurality of bins. In the example illustrated in FIG. 1, the plurality of shelves include shelves 102, 104, and 106. Each shelf 102, 104, and 106 includes at least one bin. For example, shelf 102 includes bins 102a, 102b, 102c, and 102d; shelf 104 includes bins 104a, 104b, 104c, and 104d; and shelf 106 includes bins 106a, 106b, 106c, and 106d. Each bin 102a-106d may contain one or more inventory item (e.g. SKU) at a given time. For example,

Expected item(s) 110 are inventory items that have been properly recorded as being located in a given bin. For example, bin 106c contains at least one expected item 110 that is listed in the inventory record associated with bin 106c. Because expected item(s) 110 are listed in the inventory record associated with bin 106c, and the retail backroom 100, generally, when the expected item(s) 110 need to be withdrawn from the backroom by a given retail employee, the retail employee can be directed to bin 106c to obtain the expected item(s) 110 (e.g. when restocking the storefront of the retail store or fulfilling a customer order.)

Misplaced item(s) 112 are inventory items which are recorded as being physically present within the retail backroom 100, but, in reality, are actually absent either due to being hidden, lost, damaged, or the like (e.g. “phantom inventory”). For example, a misplaced item 112 can be recorded as being within a specific bin in the retail backroom 100, but are, in fact, located in a different location either within the retail backroom 100 or in the retail store, generally. In the example illustrated in FIG. 1, misplaced item(s) 112 may be recorded as being located within bin 106c such that a given retail employee can be directed to bin 106c to withdraw the misplaced item(s) 112. However, in this instance, the misplaced item(s) 112 are either located elsewhere within the retail backroom 100 or have been lost such that the retail employee will not find them in bin 106c. In these instances, the retail employee may be unable to restock the storefront or fulfil a customer order until the misplaced item(s) 112 are either located elsewhere in the retail backroom 100 or replenished. In instances where the misplaced item(s) 112 are not found, the retail store will need to order more units of the misplaced item(s) despite still possessing all of the original units of the misplaced item(s). Typical processes for correcting misplaced inventory includes identifying when misplacement occurs (e.g. identifying and correcting the number of misplaced items 112 actually located in bin 106c) and writing off the misplaced item(s) 112 as being lost.

Furthermore, unlike IRIs related to "phantom inventory," where items are listed in the inventory system but physically absent (due to misplacement, damage, or the like), the challenge of detecting physically present but unrecorded inventory requires fundamentally different technical solutions. For example, typical solutions addressing “phantom inventory” rely on comparing expected and realizing sales as their primary signals (e.g. sales velocity). In this manner, an inventory ledger can be corrected to remove the “phantom inventory” and, in some instances, replacement units can be ordered to rectify the deficit.

In contrast, sales velocity will not help detect unrecorded inventory. If an inventory sublocation is recorded as empty (despite, in reality, containing unrecorded inventory), automated replenishment will not direct team members to pull inventory from the inventory sublocation to restock shelves. Instead, the velocity signals and the inventory record for the sublocation will both indicate that the inventory sublocation is empty. Therefore, rather than being anomalous, the velocity signal for the inventory sublocation and the inventory record will be in alignment. Thus, there is a need for a novel approach to efficiently and systematically identify and fix unrecorded inventory.

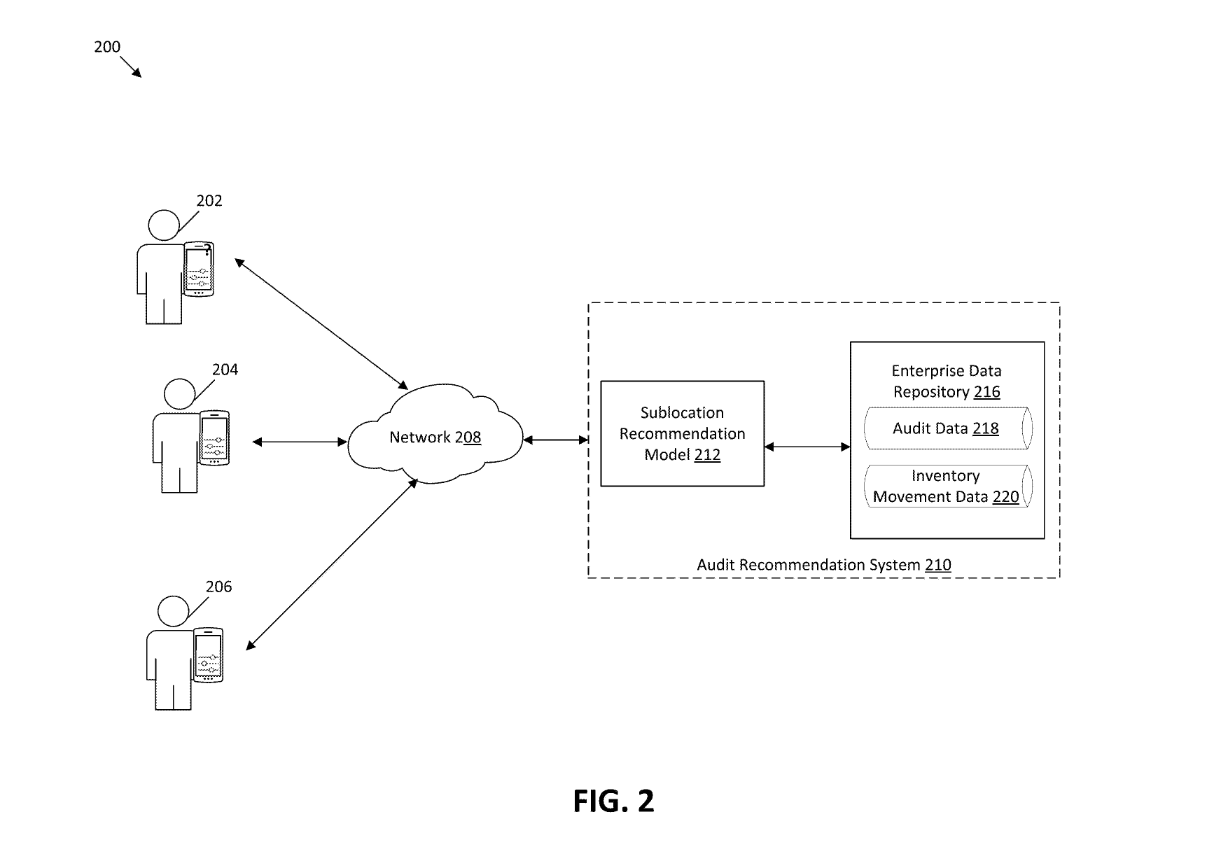

The solution further described herein, with respect to FIGS. 2-7, involves a probabilistic binary classification model to automatically identify inventory sublocations where unrecorded inventory are most likely to be found by via an audit, thus reducing the chance of a re-order unnecessarily being sent to replace the unrecorded inventory. In embodiments, the model comprises a probabilistic binary classification model configured to estimate, for each backroom sublocation, a likelihood that the sublocation contains at least one unrecorded inventory item. In such embodiments, the model outputs a probability score (e.g., a value between 0 and 1) representing the estimated likelihood of the presence of unrecorded inventory. These probability scores may be thresholded, ranked, or otherwise processed to generate audit task recommendations. Accordingly, although the model may be trained using binary classification labels, the model operates to produce continuous-valued probability outputs for use in downstream decision-making. In some implementations, a classification decision (e.g., positive or negative) may be derived by comparing the probability score to a threshold value.

FIG. 2 illustrates an example network environment 200 in which aspects of the present disclosure may be implemented. In the example shown, the network environment 200 includes an audit recommendation system 210. The audit recommendation system 210 includes a sublocation recommendation model 212 which communicates with an enterprise data repository 216. In the example shown, the enterprise data repository 216 includes audit database 218 and inventory movement database 220. In embodiments, the audit recommendation system 210 is accessible via network 208 by a variety of users 202, 204, and 206 via various types of user electronic computing devices.

The users 202, 204, and 206 can be a retail store employee of a retail enterprise. In examples, the users 202-206 can be a any store employee of a retail enterprise authorized to interact with the audit recommendation system 210. For example, users 202-206 can typically include a retail store employee such as a restocker, floor associate, cashier, store supervisor, or a contractor associated with the retail enterprise who utilizes the system to assist with audit procedures. As illustrated in FIG. 2, the users 202-206 can interact with the audit recommendation system 210 via a user electronic computing device. Example user electronic computing devices may be, for example, a smartphone, desktop computer, laptop computer, tablet, and other devices capable of rendering user interfaces and connecting to the network 208 via wireless or wired connections. As further described herein, such network-connected devices can be further configured with barcode scanning capabilities for detecting unrecorded retail inventory. In some implementations, the example computing devices can include a barcode scanner capable of connecting to the network 208 via a wireless or wired connection.

The network 208 can include any combination of local area networks (LANs), wide area networks (WANs), and the Internet, enabling communication between the various system components using standard networking protocols. In other examples, the network 208 may include another type of computer network that enables communication between the user electronic computing device of users 202-206 and the audit recommendation system 210.

The audit recommendation system 210 operates within an enterprise information system to manage and serve audit recommendations to users (e.g. users 202-206). In some implementations, the audit recommendation system 210 is in data communication with one or more data repositories and a plurality of user computing devices. For example, the audit recommendation system 210 can be in data communication with the enterprise data repository 216 and the audit data repository 218. In some implementations, the audit recommendation system 210 can be configured to serve audit recommendations to one or more of a plurality of user computing devices. In further implementations, the audit recommendation system 210 can retrieve, based on a given retail store associated with a particular user or user computer device, a subset of audit recommendations unique to the given retail store. For example, the audit recommendation system 210 can be configured to serve audit recommendations to one or more of a plurality of user computing devices, each user computing device being associated with a particular retail store within the retail enterprise. In examples, audit recommendations unique to a given retail store can be determined at the sublocation recommendation model 212.

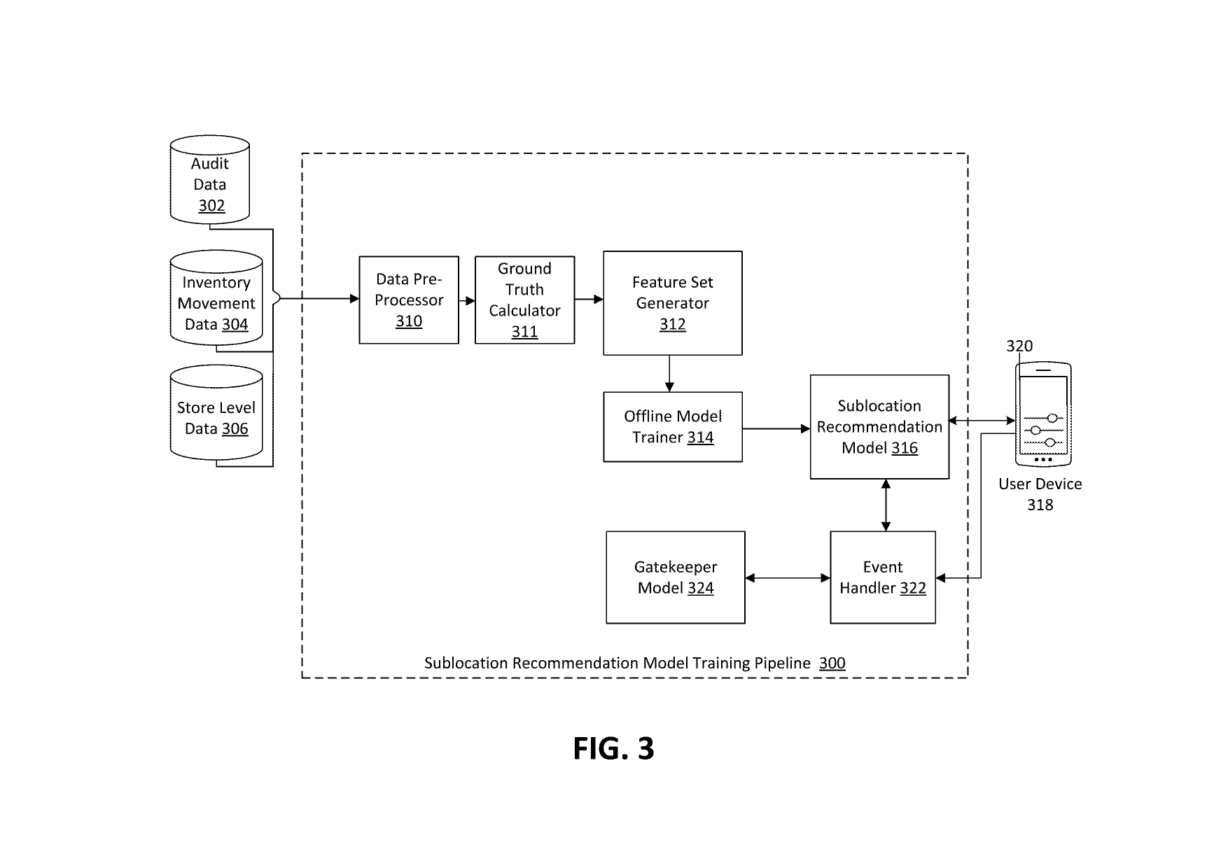

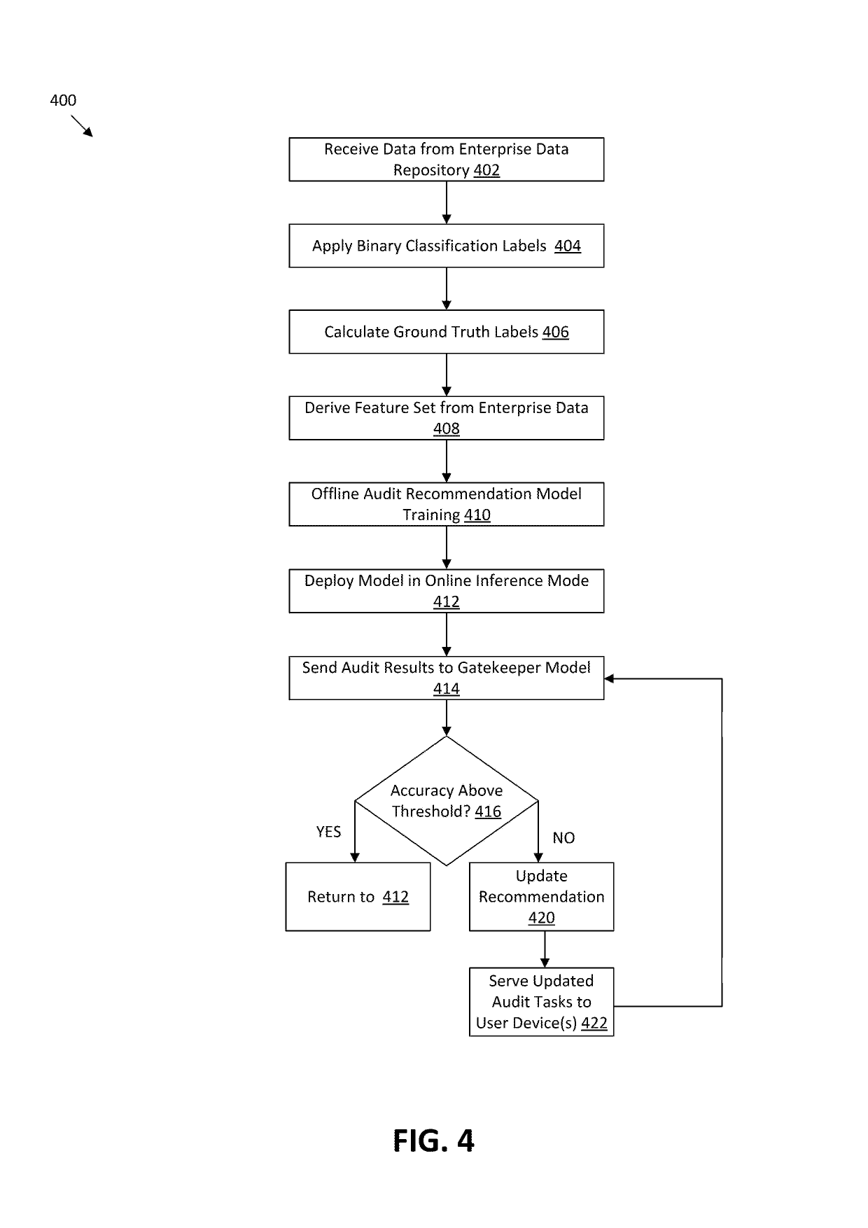

The sublocation recommendation model 212 is configured to identify one or more backroom sublocation (e.g. one or more bin) most likely to contain one or more unrecorded inventory items. For example, the sublocation recommendation model 212 can be configured to determine one or more sublocation for which an audit should be conducted to uncover an unrecorded item. In examples, the sublocation recommendation model 212 can be configured to generate probability scores identifying backroom sublocations most likely to contain one or more unrecorded inventory items. In some implementations, the sublocation recommendation model 212 can be configured to determine the respective probability of containing at least one unrecorded inventory items for each respective sublocation within the backroom of one or more retail store location. In implementations, the sublocation recommendation model 212 is a probabilistic binary classification model. In examples, data can be incorporated from the enterprise data repository to derive ground truth labels for training and evaluation of the sublocation recommendation model 212. Training, evaluation, and performance of the sublocation recommendation model 212 will be further described with respect to FIGS. 3-4.

In some embodiments, the sublocation recommendation model 212 may be implemented using a gradient boosting decision tree (GBDT) model, such as a Light Gradient Boosting Machine (LightGBM) model, Extreme Gradient Boosting (XGBoost) model, or similar ensemble learning method. Such models iteratively combine multiple decision trees to improve predictive performance by minimizing a loss function (e.g., binary cross-entropy loss) over labeled training data. In particular embodiments, a LightGBM model is utilized due to its computational efficiency and scalability for large-scale datasets, including datasets comprising millions of sublocation records and hundreds of engineered features.

The enterprise data repository 216 is configured to retain structured and unstructured data used by the audit recommendation system 210. The enterprise data repository 216 can include one or more storage systems or repositories. In an example, the enterprise data repository 216 may be implemented using on-premise databases, cloud-based storage services, or hybrid infrastructure. The enterprise data repository 216 may include multiple logically or physically distinct components, including audit database 218 and inventory movement database 220. In examples, the enterprise data repository 216 can further include store-level contextual data including sales volume, location, and other geographical information.

Audit database 218 includes the respective audit data for a given retail store location. Audit database 218 may store data related to audits conducted at a given retail store location. Audit database 218 may store data indicating which backroom sublocations at a given retail store location have been audited. Audit database 218 may store data identifying which backroom sublocations have been historically identified as containing unrecorded inventory items (e.g. via audit or via routine restocking processes). In examples, audit database 218 can store detailed data for to a plurality of audits including the type of audit performed, an identifier for the store at which the audit was performed, SKU identifiers for items recorded during the audit, personnel conducting the audit, and inventory changes recorded during the audit. In embodiments, audit database 218 can include audit data for a plurality of retail store locations.

Inventory movement database 220 includes the respective inventory data for a given retail store location. For example, inventory movement database 220 may store data capturing events such as replenishment, sales transactions, inventory quantities located in the backroom, and inventory quantities located in the salesfloor. In examples, inventory movement data can include the respective inventory data for a plurality of retail store locations.

FIG. 3 illustrates a schematic diagram of example components of an audit recommendation tool training pipeline 300. The example audit recommendation tool training pipeline 300 includes a data pre-processor 310, a ground truth calculator 311, a feature set generator 312, an offline model trainer 314, a sublocation recommendation model 316, an event handler 322, and a gatekeeper model 324. Audit database 302, inventory movement database 304, store level contextual database 306, and a user device 318 having a user interface 320 are also shown. In examples, the sublocation recommendation model training pipeline 300 can be used to train and deploy the sublocation recommendation model 316, which is an example of the sublocation recommendation model 212 described with respect to FIG. 2.

The data pre-processor 310 may be configured to ingest enterprise data into the sublocation recommendation model training pipeline 300. In the example shown, the data pre-processor ingests 310 data from the audit database 302, the inventory movement database 304, and the store level contextual database 306. The audit database 302 includes the respective audit data for one or more audits conducted at each of a plurality of respective retail store locations within the retail enterprise (e.g. annual inventory audit events, physical inventory counts, and the like). In some implementations, the audit database 302 may further include audit data generated from execution of previously served audit recommendations, including audits initiated in response to audit recommendations generated by the sublocation recommendation model 316, and other acted-upon audit events, together with corresponding audit outcomes for one or more associated backroom sublocations. In this manner, previously acted-upon recommendations generated by the sublocation recommendation model 316 can be utilized by one or more component of the sublocation recommendation model training pipeline 300 to further refine and improve subsequent recommendations presented to the user device 318 via the user interface 320. The inventory movement database 304 includes store-specific data in terms of inventory movement, replenishment, sales transactions, inventory quantities, and the like. The store level contextual database 306 includes store type, backroom sublocations, sales volume, location, and other geographical information for each of a plurality of retail store locations within the retail enterprise. In further examples, the store level contextual database 305 can include sales data related to a respective day of the week, month, and the like. In examples, the data pre-processor 310 may be further configured to standardize or filter the data received from one or more of databases 302-306 to allow for increased efficiency and accuracy in downstream operations.

The feature set generator 312 may be configured to engineer one or more set of features derived from the data received from one or more database 302-306, the data pre-processor, or both. In examples, the feature set generator 312 can be configured to generate one or more set of features using data acquired during a defined lookback period. For example, a lookback period can be equal to 15 days, 30 days, 45 days, 90 days, 180 days, or the like. In some embodiments, the feature set includes transaction-based features associated with each sublocation, including one or more of: (i) a number of inventory movement events within a predefined time window, (ii) a type of most recent transaction associated with the sublocation, (iii) a time elapsed since a last transaction, and (iv) a frequency of specific transaction types. In some implementations, low levels of transaction activity relative to expected activity for a sublocation are indicative of a likelihood that unrecorded inventory is present. In some implementations, the feature set generator 312 may generate long-term features and short-term features.

In implementations, long-term features can include aggregated features calculated over the entire lookback period. In embodiments, long-term features can include metrics such as the time elapsed since the last occurrence of a specific stockroom transaction type (e.g. restock, move, pick, etc.) or audit result (e.g. unrecorded inventory item identified or not), the number of audits performed within the lookback period, and the like. In some examples, short-term features can include stockroom transaction types and the inventory quantities associated with the most recent stockroom transactions. In examples, short-term features can include stockroom transaction types and audit results associated with a most recent n-number of transactions within the 90-day window. In some examples, short-term features can be extracted in raw from. By generating a combination of short-term and long-term features, it is possible to train the sublocation recommendation model 316 to capture both immediate and temporal patterns in inventory behavior across a plurality of sublocations. In examples, the long-term and short-term features generated by the feature set generator 312 are provided to the offline model trainer 314.

The offline model trainer 314 may be configured to train the sublocation recommendation model 316 to identify suspect sublocations where unrecorded inventory items are most likely to be found by via an audit. In examples, the offline model trainer 314 is configured to train the sublocation recommendation model 316 using data received from the feature set generator 312, data pre-processor 310, or both. In examples, the model is trained in an offline mode prior to being deployed in an online inference mode. In examples, an updated model may be trained in an offline mode simultaneously to a prior model being deployed in an online inference mode. In some implementations, the offline model trainer 314 may be configured to periodically receive updated feature sets from the feature set generator 312. In some embodiments, the offline model trainer may be configured to automatically train the sublocation recommendation model 316 upon receiving updated data from one or more of the feature set generator 312 and data pre-processor 310.

In some implementations, the offline model trainer 314 may be configured to train the sublocation recommendation model 316 using labeled training data in which each backroom sublocation is associated with a binary label indicating whether unrecorded inventory was identified during a corresponding audit. The sublocation recommendation model 316 is trained to optimize a performance metric such as area under a receiver operating characteristic curve (AUC), precision, recall, or a combination thereof. Following training, a probability threshold may be selected based on a precision-recall tradeoff to achieve a desired operational performance level, such as a target audit success rate.

The sublocation recommendation model 316 may be configured to run in an online inference mode. In some examples, the online inference mode includes a segmented daily model pipeline including inventory-related features from store-level features and execution of each as independent stages, thereby reducing the dataset required at each stage. This segmentation allows for more efficient data handling and thereby enables the scalable generation and delivery of daily audit tasks to each of a plurality of retail store locations. The sublocation recommendation model 316 can be configured to run in an online inference mode on a daily basis to generate daily audit tasks. In examples, the sublocation recommendation model 316 can be configured to generate daily audit tasks for each of a plurality of retail store locations within a retail enterprise. In examples, the sublocation recommendation model 316 can be configured to generate daily audit tasks prior to a predefined cutoff time, thus ensuring that retail store teams have sufficient time to complete the daily audit tasks within a given shift or 24-hour period.

In some embodiments, the probability scores generated by the sublocation recommendation model 316 are used to rank backroom sublocations in order of likelihood of containing unrecorded inventory. A subset of sublocations may then be selected based on one or more criteria, including a predefined probability threshold, a fixed number of audit tasks, or operational constraints such as labor availability. In some implementations, the threshold may be dynamically adjusted based on observed audit outcomes to maintain a target success rate for audit tasks. As used herein, an “operational constraint” refers to one or more conditions governing execution of audit tasks within a retail environment, including but not limited to: (i) a maximum number of audit tasks to be performed within a given time period, (ii) labor availability associated with one or more retail store locations, (iii) time-of-day or shift-based execution limits, (iv) recency of inventory activity at a sublocation, and (v) prioritization rules for balancing audit efficiency and workload distribution. Operational constraints may be predefined, dynamically determined, or updated based on system feedback.

In examples, once recommended daily audit tasks are generated by the sublocation recommendation model 316, one or more post-processing operations may be applied before they are provided to a given retail store location. For example, the audit task list may be ranked based on likelihood of finding an unrecorded inventory item at a given sublocation. In further examples, the audit task list may be backfilled with random audit locations to reach a required number of audits for a given day. In still further examples, the audit task list may be filtered based on backroom activity within a preceding period of time, such as recent transactions at a given sublocation.

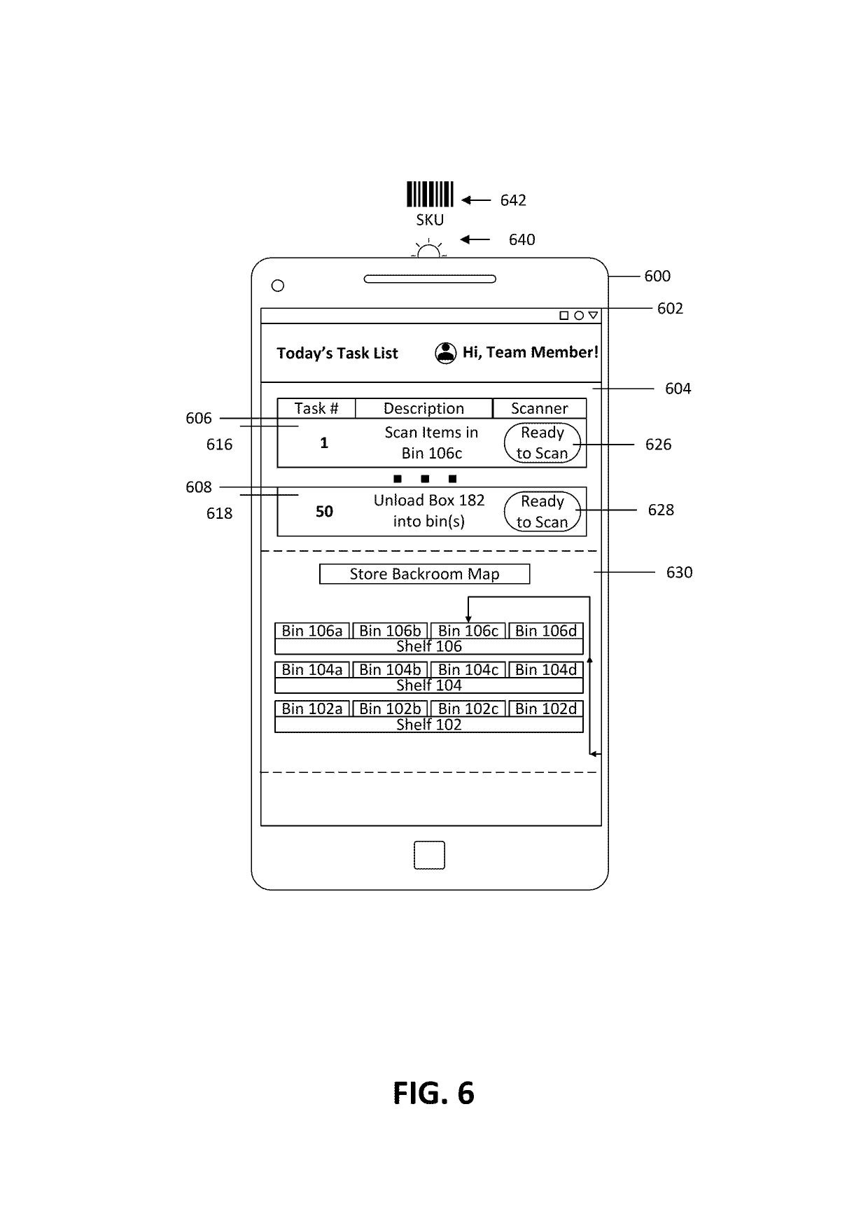

In embodiments, once a final list of audit tasks is determined for a given retail store location, a prioritized list of audit tasks can be automatically delivered to a user device 318 associated with the store location such that the retail store employee can seamlessly visit an identified sublocation and scan each of the items in that sublocation via a barcode scanner. Once the items in a given sublocation are scanned, the item SKUs present in that sublocation can be automatically updated. In examples, the result of one or more audit tasks, including the item SKUs present in a given sublocation, can be provided to the gatekeeper model 324 via the event handler 322, as feedback to the sublocation recommendation model 316, or both. In examples, the results of one or more audit tasks being executed via the user device 318 can be provided to one or more of a enterprise inventory management system, and a retail store inventory management system to update one or more inventory records. In some examples, the results of one or more audit tasks being executed via the user device 318 can be provided to the gatekeeper model 324, the sublocation recommendation model 316, or a combination thereof, to maintain or improve future audit-task quality. As illustrated in FIG. 3, the user device 318 may have a user interface 320 to assist in the identification and execution of one or more audit tasks. An example user interface is further illustrated and described herein with respect to FIG. 6.

The event handler 322 may be configured to receive data related to audit tasks executed via the user device 318. For example, the event handler 322 can be configured to receive the result of each audit task including an identification of the SKUs present in a given recommended sublocation. In examples, the event handler 322 can be configured to determine whether one or more unrecorded inventory items were identified in a given recommended sublocation based on the data received via the user device 318. In some implementations, the event handler 322 can further be configured to send the result of one or more audit tasks to downstream inventory management systems such that the inventory record for a given sublocation can be automatically updated based on the data received via the user device 318. In implementations, the event handler 322 can be configured to provide the results of one or more audit tasks received via the user device 318 to the gatekeeper model 324, the sublocation recommendation model 316, or both.

The gatekeeper model 324 may be configured to maintain accuracy and overall performance of the audit recommendation system 210. In examples, the gatekeeper model 324 can be configured to evaluate the recommendations generated by the sublocation recommendation model 316. For example, the number of unrecorded inventory items remaining in various sublocations may decrease over time due to successful audit recommendations being recommended via the sublocation recommendation model 316 and executed via a user of the user device 318. While this outcome is desirable from an inventory management standpoint, it may introduce a challenge for model maintenance and training, as the scarcity of positive labels in future audit data may degrade training effectiveness.

Accordingly, the gatekeeper model 324 can be implemented solely on post-inference mode data received via the event handler 322 to evaluate the number of recommended sublocations identified in the inference mode by the sublocation recommendation model 316 which resulted in an unidentified inventory item being uncovered via an audit and to ensure that a minimum accuracy level is maintained in terms of successful sublocation recommendations. In some embodiments, the gatekeeper model 324 may receive audit outcome data associated with one or more recommended sublocation to identify short-term shifts, seasonal variation, or other changes in audit patterns without requiring retraining of the sublocation recommendation model 316. For example, the gatekeeper model 324 can operate on post-inference data received via the event handler 322 to capture short-term shifts or seasonal variations in audit data without requiring retraining of the sublocation recommendation model 316. In examples, if the Gatekeeper model finds that the audit precision falls below a required threshold, then the Gatekeeper model can update which sublocations should be audited based on short-term shifts, seasonal variations, or operational feedback, without retraining the primary model. In some examples, the gatekeeper model 324 can be configured to provide feedback to the recommendation model 316 to adjust which sublocations should be audited or prioritized based on trends in audit accuracy, operational feedback, or both. In examples, the gatekeeper model 324 can be configured to evaluate candidate audit tasks generated by the recommendation model 316 and to filter, accept, reject, reprioritize, or supplement the candidate audit tasks based on recent audit outcomes, trends in audit accuracy, operational feedback, or a combination thereof. This layered approach helps maintain high overall system performance while managing the tradeoff between diminishing numbers of unrecorded inventory items and changing data distributions. Ultimately, by applying a gatekeeper model 324, the overall accuracy of the system can be maintained such that new unrecorded inventory items may be detected more quickly than they can occur naturally and overall rates of unrecorded inventory items can be reduced.

In some embodiments, the gatekeeper model 324 is trained using a dataset including previously generated audit recommendations and corresponding audit outcomes, such that each recommended sublocation is labeled based on whether unrecorded inventory was identified during execution of the audit task. The gatekeeper model 324 is configured to evaluate candidate audit tasks generated by the sublocation recommendation model and to selectively accept, reject, or reprioritize the candidate audit tasks based on predicted likelihood of successful audit outcomes. In some implementations, the gatekeeper model 324 filters out low-confidence recommendations and dynamically adapts the system to changes in data distribution, thereby improving overall system precision. In some implementations, the gatekeeper model outputs a confidence score or classification for each candidate audit task, and audit tasks are selectively accepted or rejected based on whether the confidence score exceeds a threshold value.

It is noted that the gatekeeper model 324 may determine whether accuracy of the sublocation recommendation model 316 is maintained within an accuracy threshold, which may, for example, determine a threshold success rate corresponding to a proportion of audit tasks that identify unrecorded inventory. As used herein, an “accuracy threshold” refers to a predefined or dynamically adjusted performance criterion associated with audit outcomes, such as a minimum precision, success rate, or proportion of audit tasks that result in identification of unrecorded inventory items. In some embodiments, the accuracy threshold corresponds to a target audit success rate (e.g., percentage of audits yielding at least one unrecorded inventory item).

Referring to FIGS. 2-3 generally, it is noted that the audit recommendation system 210 and audit recommendation tool training pipeline 300 may be implemented using a distributed computing architecture configured to process large-scale inventory and audit datasets across a plurality of retail store locations. For example, data associated with individual retail store locations or groups of sublocations may be partitioned across multiple computing nodes to enable parallel processing of feature generation, model training, and inference operations.

In some implementations, feature generation is performed using distributed data processing frameworks that execute parallel computations over partitioned datasets, such that short-term and long-term features are computed independently across multiple processing units. Similarly, model inference may be performed in parallel for multiple retail store locations, thereby enabling generation of audit task recommendations within a predefined time window. In some embodiments, the distributed architecture reduces computational latency and resource utilization by segmenting processing pipelines into independent stages, including (i) inventory-related feature computation, (ii) store-level feature computation, and (iii) model inference, each executed across distributed computing resources. In some embodiments, data is partitioned based on store identifiers, sublocation identifiers, or time intervals, enabling efficient read and write operations and scalable processing of datasets comprising millions of sublocations and associated transaction records.

In example operation 402, the data pre-processor 310 receives data the enterprise data repository. As described with respect to FIGS. 2-3, the enterprise data repository may include audit data 302, inventory movement data 304, and store level data 306.

In example operation 404, the data pre-processor 310 then applies binary classification labels to the data received from the enterprise data repository. In some implementations, the data received from the enterprise data repository can include audit records associated with one or more backroom sublocation. In examples, binary classification labels are applied to previously collected audit data received from the enterprise data repository such that, ifinventory was discovered in a given sublocation during a prior audit, that sublocation would be provided with a first binary audit label (e.g. 1). Accordingly, if unrecorded inventory was not discovered in a sublocation during a prior audit, then the corresponding sublocation may be given a second binary audit label (e.g. 0). In addition, operation 404 can include identifying sublocations not included in a given audit record. In some embodiments, operation 404 can include identifying sublocations not included in a given audit record by identifying sublocations having pre- and post- audit quantities both being equal to zero. In examples, limiting the pre-processed data only to sublocations which appear in a given audit record could inadvertently introduce sampling bias, as such audit data could disproportionately represent non-empty locations more likely to be to be audited and reduce the accuracy of downstream recommendations. For example, this could lead the model to incorrectly predict that all empty sublocations correspond to positive audit events (e.g. identification of unrecorded inventory items). Accordingly, operation 404 can further include identifying any sublocations which are absent from a given audit record and applying the second binary sublocation label to such sublocations (e.g. 0) thereby indicating that an unrecorded inventory item was not identified in such sublocations.

In example operation 406, an initial audit recommendation model can be trained based on the data derived in operations 402 and 404 such that an initial set of audit recommendations can be generated. This initial set of audit recommendations can then be conducted to generate a set of initial audit results. These initial audit results can then be incorporated into a ground truth data set. For example, a ground truth calculator 311 can combine the initial set of audit recommendations with their respective feature fields and the initial audit results to log a ground truth dataset. This dataset can be stored to further train and evaluate the sublocation recommendation model 316, the gatekeeper model 324, or both.

In example operation 408, the feature set generator 312 may engineer one or more set of features derived from the data received from the enterprise data repository, the data pre-processor 310, or both. In examples, the feature set generator 312 can generate one or more set of features using data acquired during a defined lookback period. For example, a lookback period can be equal to 15 days, 30 days, 45 days, 90 days, 180 days, or the like. In some implementations, the feature set generator 312 may generate long-term features and short-term features. In implementations, long-term features can include aggregated features calculated over the entire lookback period. In embodiments, long-term features can include metrics such as the time elapsed since the last occurrence of a specific stockroom transaction type (e.g. restock, move, pick, etc.) or audit result (e.g. unrecorded inventory item identified or not), the number of audits performed within the lookback period, and the like. In some examples, short-term features can include stockroom transaction types and the inventory quantities associated with the most recent stockroom transactions. In examples, short-term features can include stockroom transaction types and audit results associated with a most recent n-number of transactions within the 90-day window.

In example operation 410, the offline model trainer 314 may train the sublocation recommendation model 316 to identify suspect sublocations where unrecorded inventory items are most likely to be found by via an audit. In examples, the offline model trainer 314 can train the sublocation recommendation model 316 using data received from the feature set generator 312, data pre-processor 310, or both. In examples, the sublocation recommendation model 316 is trained in an offline mode prior to being deployed in an online inference mode. In examples, an updated model may be trained in an offline mode simultaneously to a prior model being deployed in an online inference mode. In some implementations, the offline model trainer 314 may be configured to periodically receive updated feature sets from the feature set generator 312. In some embodiments, the offline model trainer may be configured to automatically train the sublocation recommendation model 316 upon receiving updated data from one or more of the feature set generator 312 and data pre-processor 310. Training the sublocation recommendation model 316 in an offline mode can increase efficiency by ensuring that offline training occurs during low-data traffic periods of the day, controlling when updated data may be ingested, and the like.

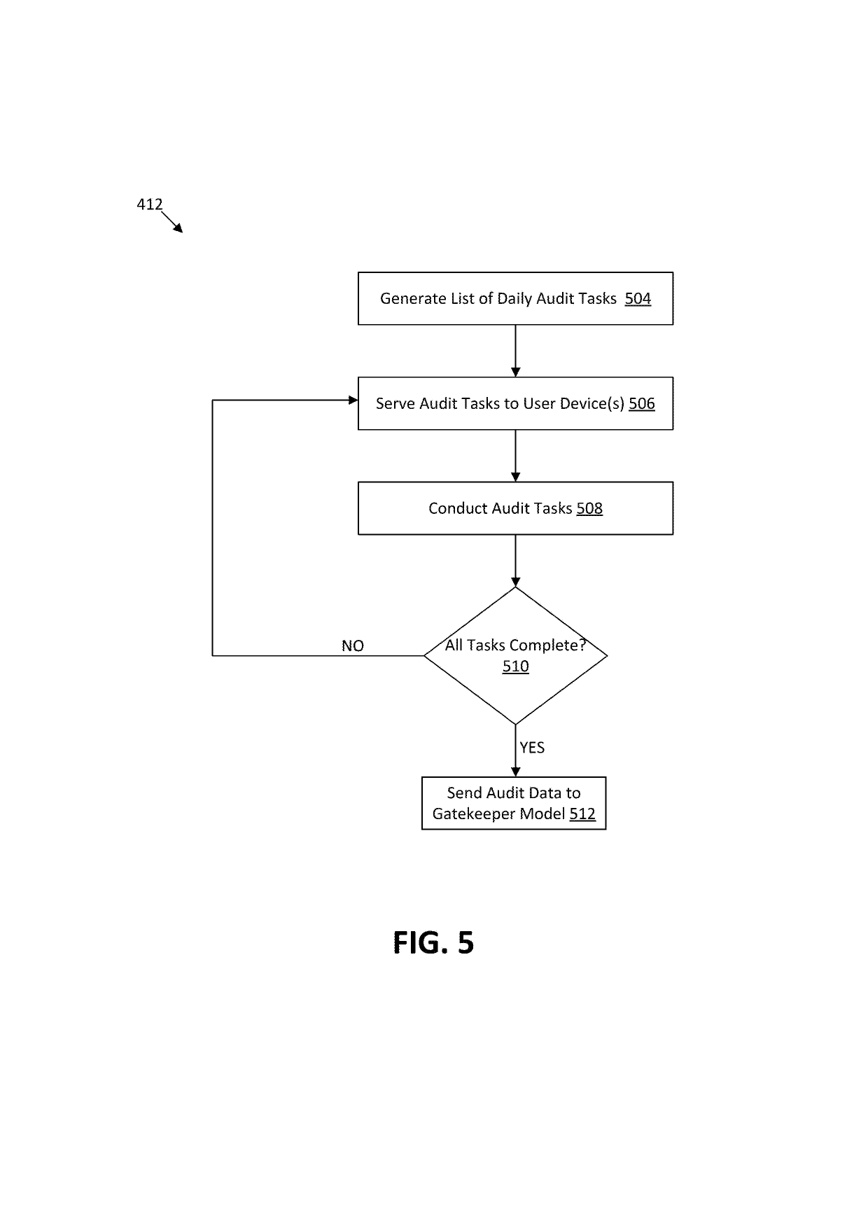

In example operation 412, the sublocation recommendation model 316 may be deployed in an online inference mode. In examples, the sublocation recommendation model 316 can be configured to run in an online inference mode on a daily basis to generate daily audit tasks. For example, the sublocation recommendation model 316 can be configured to generate daily audit tasks for each of a plurality of retail store locations within a retail enterprise. In examples, the sublocation recommendation model 316 can be configured to generate daily audit tasks prior to a predefined cutoff time, thus ensuring that retail store teams have sufficient time to complete the daily audit tasks within a given shift or 24-hour period. In some embodiments, the online inference mode includes a segmented daily model pipeline including inventory-related features from store-level features and execution of each as independent stages, thereby reducing the dataset required at each stage. This segmentation allows for more efficient data handling and thereby enables the scalable generation and delivery of daily audit tasks to each of a plurality of retail store locations. An example operation 412 is further illustrated and described with respect to FIG. 5.

In example operation 414, audit result data related to audit tasks executed via the user device 318, including the item SKUs present in a given sublocation, can be sent to the gatekeeper model 324 by the user device 318, the event handler 322, or a combination thereof. In examples, the audit results can include a determination of whether one or more unrecorded inventory items was identified in a given recommended sublocation.

In example operation 416, the gatekeeper model 324 may evaluate the accuracy of the sublocation recommendations generated by the sublocation recommendation model 316 based on the audit results. For example, the gatekeeper model 324 can evaluate the number of recommended sublocations identified in the inference mode of the sublocation recommendation model 316 which resulted in an unidentified inventory item being uncovered via an audit to determine whether the accuracy level in terms of successful sublocation recommendations is above a predetermined threshold. In examples, if the accuracy is determined to be at or above the predetermined threshold, then the method 400 may return to operation 412. In examples, if the accuracy is determined to be below the predetermined threshold, then the gatekeeper model may proceed to operation 420.

In example operation 420, the gatekeeper model 324 is configured to update the sublocation recommendations. In embodiments, the Gatekeeper model can automatically generate an updated list of audit tasks based on short-term shifts, seasonal variations, or operational feedback, without retraining the primary sublocation recommendation model 316. In some examples, the updated list of audit tasks may include one or more of the sublocations generated by the sublocation recommendation model 316, a different prioritization of the one or more of the sublocations generated by the sublocation recommendation model 316, a new sublocation recommendation, or a combination thereof. In examples, the updated list of audit tasks can include one or more randomized sublocations to explore different areas of the retail backroom 100, obtain further, refreshed data for future model training and evaluation, and the like.

In example operation 422, the updated list of audit tasks can be served to one or more user device 318. In examples, the user device may have a user interface 320 to assist in the identification and execution of one or more audit tasks. In some implementations, the user device may be integrated with a barcode scanner to enable a retail store employee to efficiently complete a given audit task and automatically provide the results to an inventory management system. An example user device and user interface are further illustrated and described herein with respect to FIG. 6.

FIG. 5 is a flowchart of an example method for deploying the sublocation recommendation model 316, in accordance with an example embodiment. The example method 500 may include operations 504-512.

In example operation 504, the sublocation recommendation model 316 generates a list of daily audit tasks. As further illustrated and described with respect to FIGS. 2-3, the audit task list may be ranked based on likelihood of finding an unrecorded inventory item at a given sublocation. In further examples, the audit task list may be backfilled with random audit locations to reach a required number of audits for a given day. In still further examples, the audit task list may be filtered based on backroom activity within a preceding period of time, such as recent transactions at a given sublocation.

In example operation 506, the sublocation recommendation model 316 serves the list of daily audit tasks to one or more user device 318. The user device may have a user interface 320 to assist in the identification and execution of one or more audit tasks. An example user device and user interface are further illustrated and described herein with respect to FIG. 6.

In example operation 508, the daily audit tasks are conducted via the one or more user device 318. In embodiments, the user device can be integrated with a barcode scanner such that a retail store employee can conduct a given audit task by finding an identified sublocation and scanning each of the items in that sublocation via the barcode scanner. Once the items in a given sublocation are scanned, the item SKUs present in that sublocation can be automatically updated.

In example operation 510, the user device 318 is configured to determine whether all daily audit tasks received from the sublocation recommendation model 316 have been completed. If additional audit tasks remain, then the method may return to operation 506 at which point the next audit task can be served to the user device 318 via the sublocation recommendation model 316. In other implementations, if additional audit tasks remain, then the method may return to operation 508 such that a retail store employee can simply advance to the next audit task already displayed on the user device 318. If all audit tasks have been completed, then the method will advance to operation 512.

In example operation 512, once all audit tasks have been completed in a given day, the corresponding audit data can be provided to the gatekeeper model 324. In examples, the audit data can be provided to the gatekeeper model 324 via the event handler 322. Example operations of the gatekeeper model are further illustrated and described with respect to FIGS. 3-4.

FIG. 6 illustrates a user interface, according to an example embodiment. The example of FIG. 6 includes a computing device 600 displaying an example user interface 602. In the example shown, the user interface 602 includes a task list 604 and a store backroom map 630. In some examples, the task list 604 of the user interface 602 may be configured to display one or more audit tasks generated by the components illustrated and described with respect to FIGS. 2-3. For example, the task list 604 may be configured to present one or more audit tasks received from the sublocation recommendation model 212. A barcode scanner 640 and an example product identification label 642 are also illustrated.

The computing device 600 can be any device operable by a user to interact with network 208, as illustrated and described with respect to FIG. 2. The computing device 600 may be, for example, a mobile device, a tablet, a desktop device a smart watch, or another wired or wireless computing device with a user interface. For example, computing device 600 may display a user interface 602 to a user. In some implementations, computing device 600 may be a device used by any of enterprise users 202-206 described with respect to FIG. 2.

As briefly described above, the example user interface 602 may be displayed on the computing device 600. In the example illustrated in FIG. 6, the user interface 602 is configured to display a task list 604. For example, the task list 604 can include one or more daily tasks assigned to a given retail store employee of a retail enterprise to be completed during a given shift. In examples, if one or more tasks displayed in the task list 604 remain at the end of the given shift of the given retail store employee, then the remaining tasks can be reassigned to a second retail store employee upon beginning a subsequent shift. In this manner, a daily list of audit tasks generated by the components described with respect to FIGS. 2-3 can be flexibly completed over the course of a given day by one or more retail store employee as time permits during the respective shift of each retail store employee. The task list 604 can include one or more audit tasks (e.g. task 606). In examples, the one or more audit tasks can be listed by order of priority. For example, the one or more audit tasks displayed in the task list 604 can be prioritized based on the probability that the sublocation associated with each respective audit task includes one or more unrecorded inventory items. In some examples, the task list 604 can further include one or more non-audit task (e.g. task 608). In this manner, audit tasks identified via the components described with respect to FIGS. 2-3 can be seamlessly integrated into the daily workflow of one or more retail store employee in an efficient, prioritized manner alongside the execution of non-audit tasks.

The audit task 606 can include a description 616 including one or more of the sublocation associated with the audit task 606 and instructions for how to complete the audit task 606. In some implementations, the task description 616 can include a task number. In some examples, the task number can indicate a priority of the task 606 ahead of other tasks included in the task list 604. In some examples, the audit task 606 can include a selectable icon 626 configured to allow the retail store employee to execute the audit task 606. For example, the selectable icon 626 can be configured to allow the retail store employee to activate the barcode scanner 640. For example, the retail store employee can scan a respective label 642 associated with each respective item found within the sublocation identified by the audit task 606. In examples, once each respective item found with the sublocation identified by the audit task 606 has been scanned via the barcode scanner 640, the retail store employee may then indicate that the audit task 606 has been completed such that the retail store employee may then proceed to the next task included in the task list 604.

The task 608 is a non-audit task. For example, task 608 can be a standard task related to inventory management, warehouse operations, store maintenance, and the like. For example, the task 608 can include a description 618 including instructions for completing the task. In some implementations, the description 618 can include a task number. In some examples, the task number can indicate a priority of the task 608 ahead of other tasks included in the task list 604. In some examples, the task 608 can include a selectable icon 628 configured to allow the retail store employee to execute the task 608.

In some implementations, the user interface 602 may optionally be configured to display a store backroom map 630. In examples, the store backroom map 630 can display the location of one or more bin. As illustrated in the example of FIG. 6, the store backroom map 630 is configured to display the location of a bin identified in audit task 606.

As briefly described above, the computing device 600 of the example illustrated in FIG. 6 is coupled to a barcode scanner 640 configured to scan a product identification label configured to identify a respective item, item SKU, and the like (e.g. barcode 642). For example, a user can complete one or more audit tasks displayed on the user interface by scanning each item found in an identified sublocation with the barcode scanner 640. In this manner, any unrecorded inventory items within the identified sublocation can be automatically recorded and identified via the audit information collected via the barcode scanner 640. Furthermore, the audit information collected via the barcode scanner 640 can be provided as feedback to the sublocation recommendation model 212 for model feedback and future audit list generation.

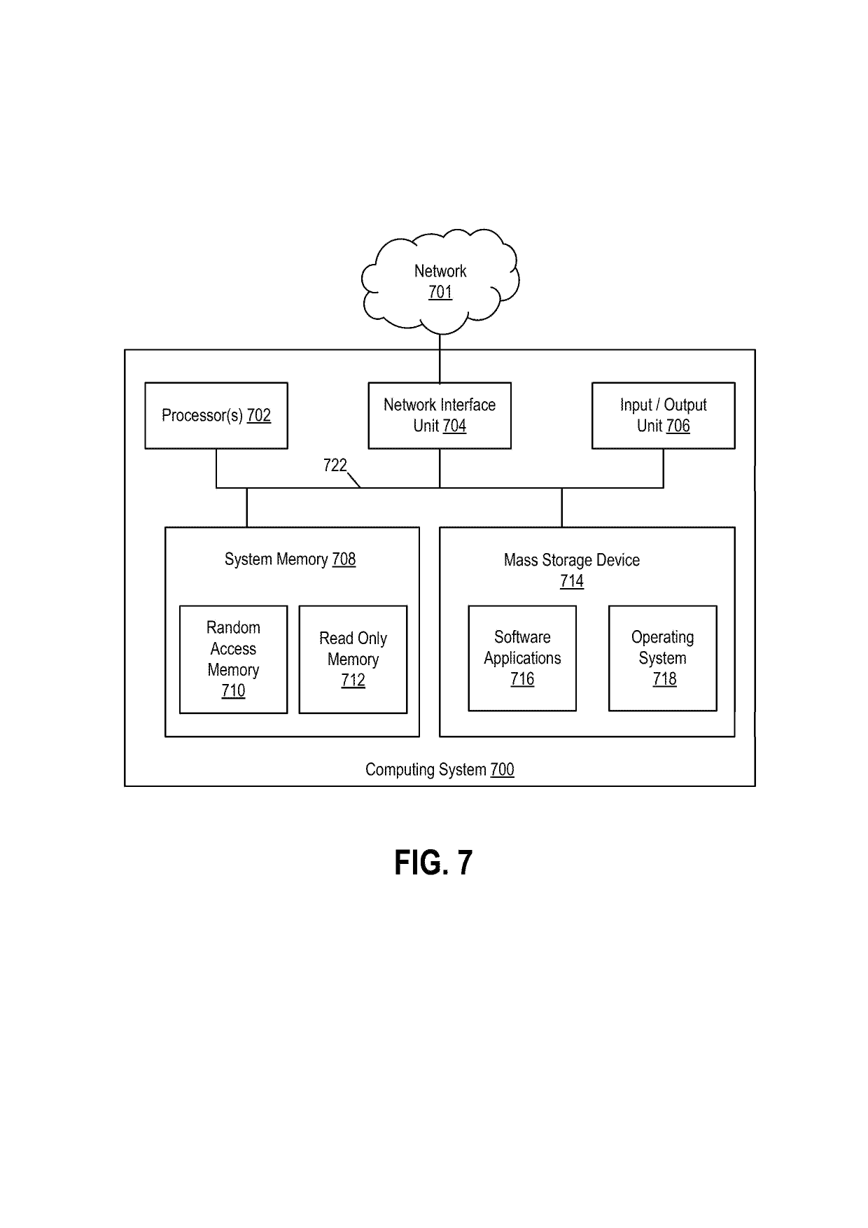

FIG. 7 illustrates an example block diagram of a virtual or physical computing system 700. One or more aspects of the computing system 700 can be used to implement the processes described herein.

In the embodiment shown, the computing system 700 includes one or more processors 702, a system memory 708, and a system bus 722 that couples the system memory 708 to the one or more processors 702. The system memory 708 includes RAM (Random Access Memory) 710 and ROM (Read-Only Memory) 712. A basic input/output system that contains the basic routines that help to transfer information between elements within the computing system 700, such as during startup, is stored in the ROM 712. The computing system 700 further includes a mass storage device 714. The mass storage device 714 is able to store software instructions and data. The one or more processors 702 can be one or more central processing units or other processors.

The mass storage device 714 is connected to the one or more processors 702 through a mass storage controller (not shown) connected to the system bus 722. The mass storage device 714 and its associated computer-readable data storage media provide non-volatile, non-transitory storage for the computing system 700. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 700.

According to various embodiments of the invention, the computing system 700 may operate in a networked environment using logical connections to remote network devices through the network 701. The network 701 is a computer network, such as an enterprise intranet and/or the Internet. The network 701 can include a LAN, a Wide Area Network (WAN), the Internet, wireless transmission mediums, wired transmission mediums, other networks, and combinations thereof. The computing system 700 may connect to the network 701 through a network interface unit 704 connected to the system bus 722. It should be appreciated that the network interface unit 704 may also be utilized to connect to other types of networks and remote computing systems. The computing system 700 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the computing system 700 can store software instructions and data. The software instructions include an operating system 718 suitable for controlling the operation of the computing system 700. The mass storage device 714 and/or the RAM 710 also store software instructions, that when executed by the one or more processors 702, cause one or more of the systems, devices, or components described herein to provide functionality described herein. For example, the mass storage device 714 and/or the RAM 710 can store software instructions that, when executed by the one or more processors 702, cause the computing system 700 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of recommendation systems, technologies disclosed herein are applicable to data and methods for validation of recommendations generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

We claim:

1. A computer-implemented method for detecting unrecorded retail inventory, comprising:
receiving inventory movement data and historical audit data from a plurality of retail store locations;
generating a feature set comprising short-term features and long-term features;
processing the feature set using a machine learning model configured to generate probability scores identifying backroom sublocations most likely to contain one or more unrecorded inventory items;
generating a plurality of audit tasks for backroom sublocations based on the probability scores;
causing execution of one or more of the plurality of audit tasks by transmitting the audit tasks to a user device and receiving audit result data; and
updating the machine learning model based on feedback data from the executed audit tasks.

2. The computer-implemented method of claim 1, wherein generating short-term features comprises extracting backroom transaction types and associated inventory quantities for a selected number of recent backroom transactions over a lookback period.

3. The computer-implemented method of claim 2, wherein generating long-term features comprises extracting backroom transaction types and associated inventory quantities for a selected number of recent backroom transactions over an extended lookback period and incorporating temporal audit metrics including the number and type of audits performed within a given period.

4. The computer-implemented method of claim 1, wherein updating the machine learning model comprises providing feedback data to a gatekeeper model configured to handle distribution shifts in inventory and transaction data.

5. The computer-implemented method of claim 1, wherein generating a plurality of audit tasks comprises:
ranking the plurality of backroom sublocations based on the probability scores;
generating a predetermined number of audit tasks per retail location per period; and
distributing audit tasks to store personnel at each retail location.

6. The computer-implemented method of claim 5, wherein generating a plurality of audit tasks further comprises filtering the plurality of backroom sublocations based on one or more operational constraints including at least one of a task count limit, labor availability, or recency of sublocation activity.

7. The computer-implemented method of claim 5, wherein distributing the audit tasks to store personnel includes displaying one or more audit tasks on a user interface of a computing device, wherein the computing device is further configured to scan one or more item within the plurality of backroom sublocations to identify unrecorded retail inventory and generate feedback data.

8. A system for detecting unrecorded retail inventory, comprising:
one or more processors;
memory storing instructions that, when executed by the one or more processors, cause the system to:
receive inventory movement data and historical audit data from a plurality of retail store locations;
generate a feature set comprising short-term features and long-term features;
process the feature set using a machine learning model configured to generate probability scores identifying backroom sublocations most likely to contain one or more unrecorded inventory items;
generate a plurality of audit tasks for backroom sublocations based on the probability scores;
causing execution of one or more of the plurality of audit tasks by transmitting the audit tasks to a user device and receiving audit result data; and
update the machine learning model based on feedback data from the executed audit tasks.

9. The system of claim 8, wherein generating short-term features comprises extracting backroom transaction types and associated inventory quantities for a selected number of recent backroom transactions over a lookback period.

10. The system of claim 9, wherein generating long-term features comprises extracting backroom transaction types and associated inventory quantities for a selected number of recent backroom transactions over an extended lookback period and incorporating temporal audit metrics including the number and type of audits performed within a given period.

11. The system of claim 8, wherein updating the machine learning model comprises providing feedback data to a gatekeeper model configured to handle distribution shifts in inventory and transaction data.

12. The system of claim 8, wherein generating a plurality of audit tasks comprises:
ranking the plurality of backroom sublocations based on the probability scores;
generating a predetermined number of audit tasks per retail location per period; and
distributing audit tasks to store personnel at each retail location.

13. The system of claim 12, wherein generating a plurality of audit tasks further comprises filtering the plurality of backroom sublocations based on one or more operational constraints including at least one of a task count limit, labor availability, or recency of sublocation activity.

14. The system of claim 12, wherein distributing the audit tasks to store personnel includes displaying one or more audit tasks on a user interface of a computing device, wherein the computing device is further configured to scan one or more item within the plurality of backroom sublocations to identify unrecorded retail inventory and generate feedback data.

15. A non-transitory computer-readable medium storing instructions that, when executed by one or more processors, cause the one or more processors to perform operations comprising:
receiving inventory movement data and historical audit data from a plurality of retail store locations;
generating a feature set comprising short-term features and long-term features;
processing the feature set using a machine learning model configured to generate probability scores identifying backroom sublocations most likely to contain one or more unrecorded inventory items;
generating a plurality of audit tasks for backroom sublocations based on the probability scores;
causing execution of one or more of the plurality of audit tasks by transmitting the audit tasks to a user device and receiving audit result data; and
updating the machine learning model based on feedback data from the executed audit tasks.

16. The computer-readable medium of claim 15, wherein generating short-term features comprises extracting backroom transaction types and associated inventory quantities for a selected number of recent backroom transactions over a lookback period and wherein generating long-term features comprises extracting backroom transaction types and associated inventory quantities for a selected number of recent backroom transactions over an extended lookback period and incorporating temporal audit metrics including the number and type of audits performed within a given period.

17. The computer-readable medium of claim 15, wherein updating the machine learning model comprises providing feedback data to a gatekeeper model configured to handle distribution shifts in inventory and transaction data.

18. The computer-readable medium of claim 15, wherein generating a plurality of audit tasks comprises:
ranking the plurality of backroom sublocations based on the probability scores;
generating a predetermined number of audit tasks per retail location per period; and
distributing audit tasks to store personnel at each retail location.

19. The computer-readable medium of claim 18, wherein generating a plurality of audit tasks further comprises filtering the plurality of backroom sublocations based on one or more operational constraints including at least one of a task count limit, labor availability, or recency of sublocation activity.

20. The computer-readable medium of claim 18, wherein distributing the audit tasks to store personnel includes displaying one or more audit tasks on a user interface of a computing
device, wherein the computing device is further configured to scan one or more item within the plurality of backroom sublocations to identify unrecorded retail inventory.
